(19) United States
(12) Patent Application Publication
(10) Pub. No.: US 2016/0308382 A1
(43) Pub. Date: Oct. 20, 2016

(54) VEHICLE EMERGENCY STARTER SUPPLEMENTARY DEVICE

(71) Applicant: C-TECH UNITED CORP., New Taipei City (TW)

(72) Inventor: Hsin-Tai PAN, New Taipei City (TW)

(21) Appl. No.: 14/688,261

(22) Filed: Apr. 16, 2015

(51) Int. Cl. H02J 7/00

(52) U.S. Cl. CPC H02J 7/0054; H02J 7/0042; H02J 7/007; H02J 2007/0062

(57) ABSTRACT

A vehicle emergency starter supplementary device includes a power input end for the connection of an external mobile power supply device for power input, a power output end, a cigarette lighter receptacle applicable power cable for electrically and detachably connecting the power output end to a cigarette lighter receptacle in a motor vehicle for power output, a control unit, a voltage regulator circuit controlled by the control unit to regulate the voltage of input power for outputting to the power output end, and an input terminal sensor controllable by the control unit to detect the voltage of the input power, an output terminal sensor controllable by the control unit to detect the voltage of the output power.

### BACKGROUND OF THE INVENTION

1. Field of the Invention

The present invention relates to vehicle battery charging technology and more particularly, to a vehicle emergency starter supplementary device, which can be used inside a vehicle to electrically connect a mobile power supply device to the cigarette lighter receptacle of the vehicle for charging the battery of the vehicle so that the driver needs not to leave the vehicle when charging the battery of the vehicle.

2. Description of the Related Art

If a motor vehicle, such as car, motorcycle or water scooter cannot be started due to battery low or aged battery, the normal emergency rescue procedure is to charge the car battery with an external power source.

When charging the car battery, the user needs to open the engine compartment lid, and then disconnect the battery wires, and then fasten battery clamps of a jumper cable to the positive and negative terminals of the car battery to charge the car battery with an external power source. Due to the constraint of current limit, this car battery charging operation must be performed by a technician or skilled person.

In order for ordinary people to charge the car battery conveniently, a specific voltage mobile power supply devices 100 are created. A specific voltage mobile power supply device 100 of this design, as shown in FIG. 1, is a battery charger convenient for use by an ordinary person without special skills. However, this specific voltage mobile power supply device 100 must be used with a jumper cable 101 for charging a vehicle battery. Before application, the user needs to open the engine compartment lid, and then fasten the battery clamps of the jumper cable 101 to the positive and negative terminals of the vehicle battery to charge the vehicle battery with specific voltage mobile power supply device 100. However, to certain female drivers or people without relevant mechanical knowledge, this procedure of opening the engine compartment lid and then fastening the battery clamps of the jumper cable to the positive and negative terminals of the vehicle battery is regarded as a dangerous road.

Further, in a bad weather state such as cold rainy day, the user must go out of the vehicle (such as car) and then fasten the terminal clamps of the jumper cable to the terminals of the vehicle battery. This operation manner is inconvenient and dangerous, and the vehicle may be not successfully started because of the low temperature.

In order to eliminate the aforesaid problem, an improved design of car battery charger or emergency rescue starter equipped with a power cable connectable to a cigarette lighter receptacle in a car is created. As illustrated in FIG. 2, this design of car battery charger or emergency rescue starter comprises a housing 102, and a power cable 103 extended out of the housing 102 for connection to a cigarette lighter receptacle in a vehicle. Thus, a female user or ordinary person without relevant mechanical knowledge can use this design of car battery charger or emergency rescue starter inside the vehicle to charge the vehicle battery conveniently and safely. However, this design of car battery charger or emergency rescue starter is an integrated device specifically designed for connection to a cigarette lighter receptacle, not applicable for other purposes. Nowadays, mobile communication devices (such as smart phone) are widely used, and the ratio that people carry a mobile power supply device when going outside is rising. However, the aforesaid improved design of car battery charger or emergency rescue starter is not suitable for charging the battery of a mobile electronic device.

### SUMMARY OF THE INVENTION

The present invention has been accomplished under the circumstances in view. It is the main object of the present invention to provide a vehicle emergency starter supplementary device, which allows the driver of a motor vehicle to charge the vehicle battery of the motor vehicle with a mobile power supply device conveniently without leaving the motor vehicle.

To achieve this and other objects of the invention, a vehicle emergency starter supplementary device comprises a housing, a power input end located at one end of the housing for the connection of an external mobile power supply device, a power output end located at an opposite end of the housing, a control unit mounted inside the housing, a voltage regulator circuit mounted inside the housing and electrically connected to the control unit and having an input end thereof electrically coupled with the power input end and an output end thereof electrically coupled with the power output end, an input terminal sensor electrically connected to the power input end and the control unit and controllable by the control unit to detect the voltage of a power supply being inputted into the power input end, an output terminal sensor electrically connected to the power output end and the control unit and controllable by the control unit to detect the voltage of the power supply being outputted through the power output end, and a cigarette lighter receptacle applicable power cable adapted for electrically and detachably connecting the power output end to a cigarette lighter receptacle in a motor vehicle.

Preferably, the vehicle emergency starter supplementary device further comprises an input terminal switch electrically connected between the power input end and the input end of the voltage regulator circuit and controllable by the control unit for power input, and an output terminal switch electrically connected between the output end of the voltage regulator circuit and the power output end and controllable by the control unit for power output.

Preferably the vehicle emergency starter supplementary device further comprises a display electrically connected to said control unit and controllable by said control unit to display data. Further, the display can be a LED display, a LCD display, or a communication interface module display.

Preferably, the of the vehicle emergency starter supplementary device as claimed in claim 1, wherein said power output end further comprises a USB connector for connection to an external electronic device through a USB cable.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating a battery charger jump starter according to the prior art.

FIG. 2 is a schematic drawing illustrating a cigarette lighter outlet connectable starter charger according to the prior art.

FIG. 3 is a perspective view of a vehicle emergency starter supplementary device in accordance with the present invention.

FIG. 4 corresponds to FIG. 3 when viewed from another angle.

FIG. 5 is a system block diagram of the vehicle emergency starter supplementary device in accordance with the present invention.

FIG. 6 is a schematic exploded view of the present invention, illustrating the vehicle emergency starter supplementary device arranged between a mobile power supply device and a cigarette lighter receptacle applicable power cable before connection.

FIG. 7 is an oblique top elevational view of an alternate form of the vehicle emergency starter supplementary device in accordance with the present invention.

FIG. 8 is a schematic exploded view of the present invention, illustrating the alternate form of vehicle emergency starter supplementary device arranged between a mobile power supply device and two different power cables before connection.

FIG. 9 is a schematic applied view of the present invention, illustrating the vehicle emergency starter supplementary device has its power input end connected with a mobile power supply device and its power output end connected to the cigarette lighter receptacle in a motor vehicle through a cigarette lighter receptacle applicable power cable.

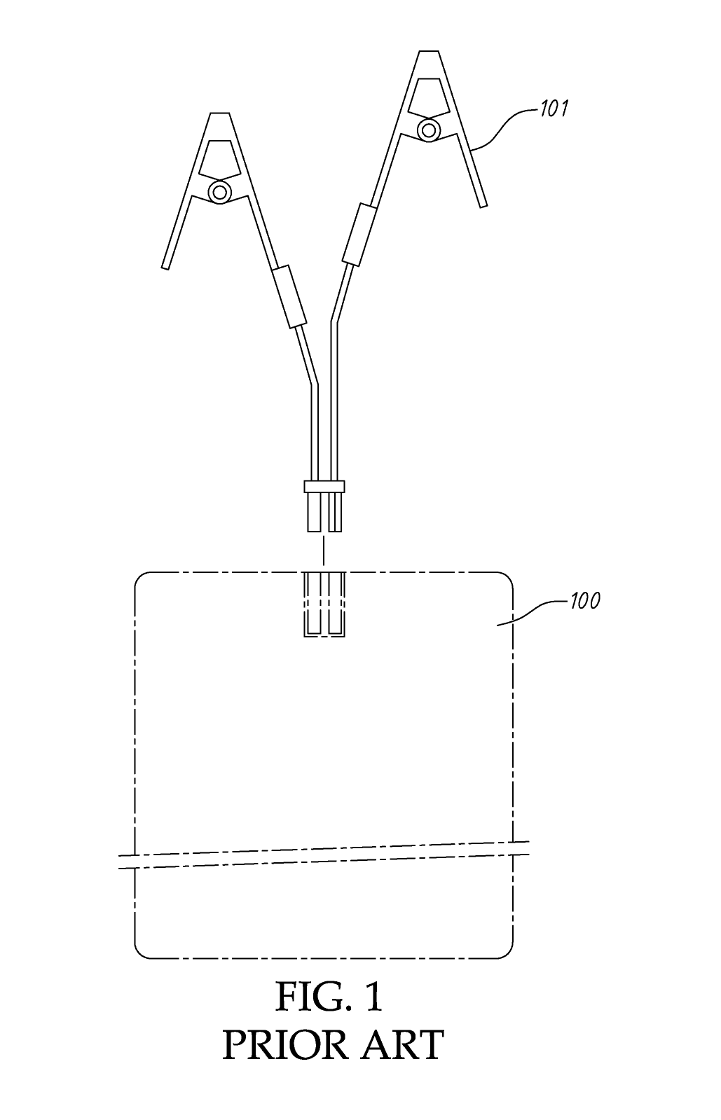

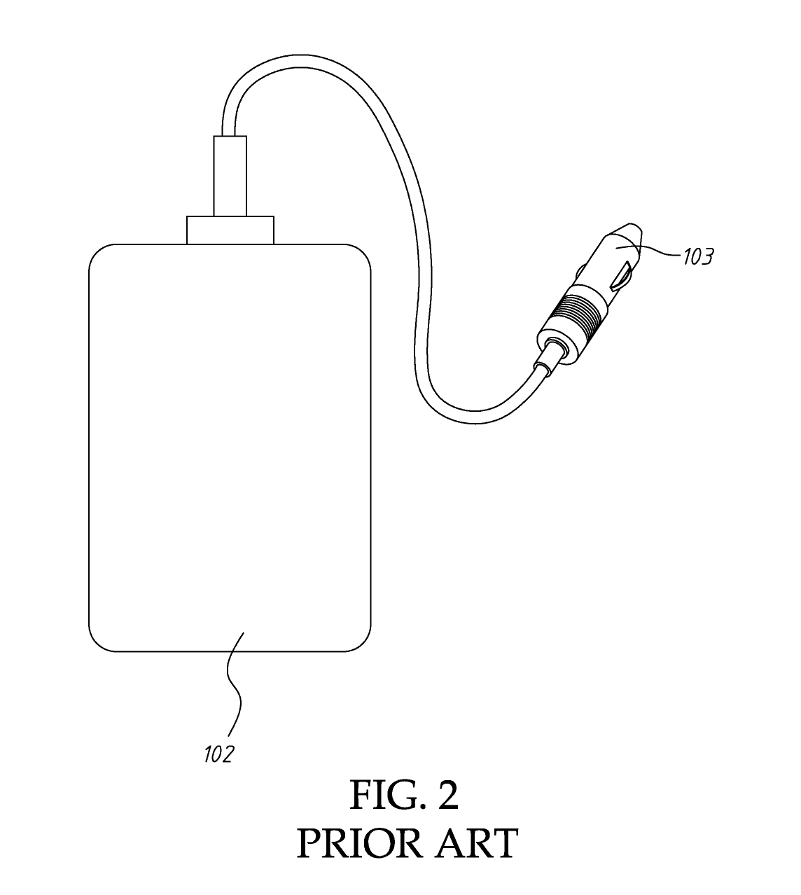

### DETAILED DESCRIPTION OF THE PREFERRED EMBODIMENT

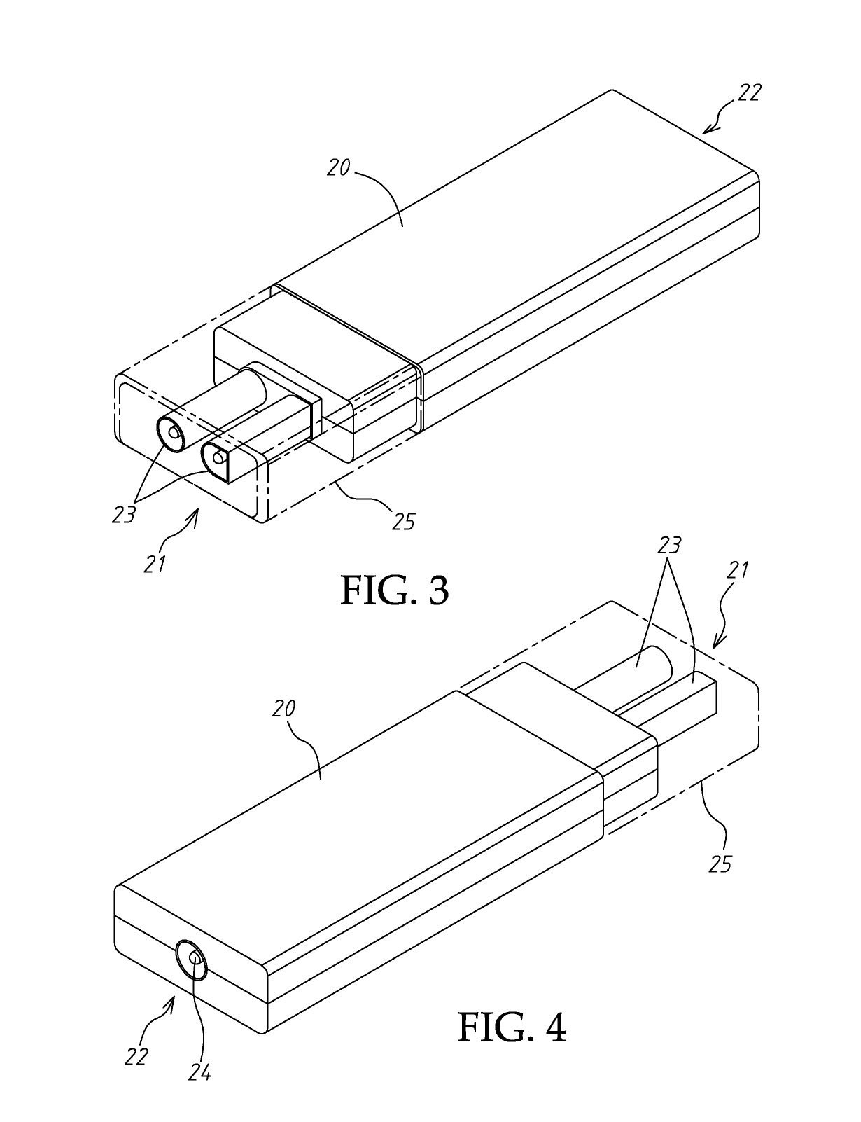

Referring to FIGS. 3 and 4, a vehicle emergency starter supplementary device in accordance with the present invention is shown. The vehicle emergency starter supplementary device comprises a housing 20 made in the form of an elongated casing convenient for carrying and operation. However, this shape is just an example but not a limitation.

The vehicle emergency starter supplementary device further comprises a power input end 21 located at one end (the left end in FIG. 3) of the housing 20, and a power output end 22 located at an opposite end (the right end in FIG. 3) of the housing 20. In this embodiment, the power input end 21 comprises a set of normalized plug terminals 23, and a protective cap 25 detachably capped on one end of the housing 20 in a flush manner to keep the plug terminals 23 from sight; the power output end 22 comprises an electric jack 24.

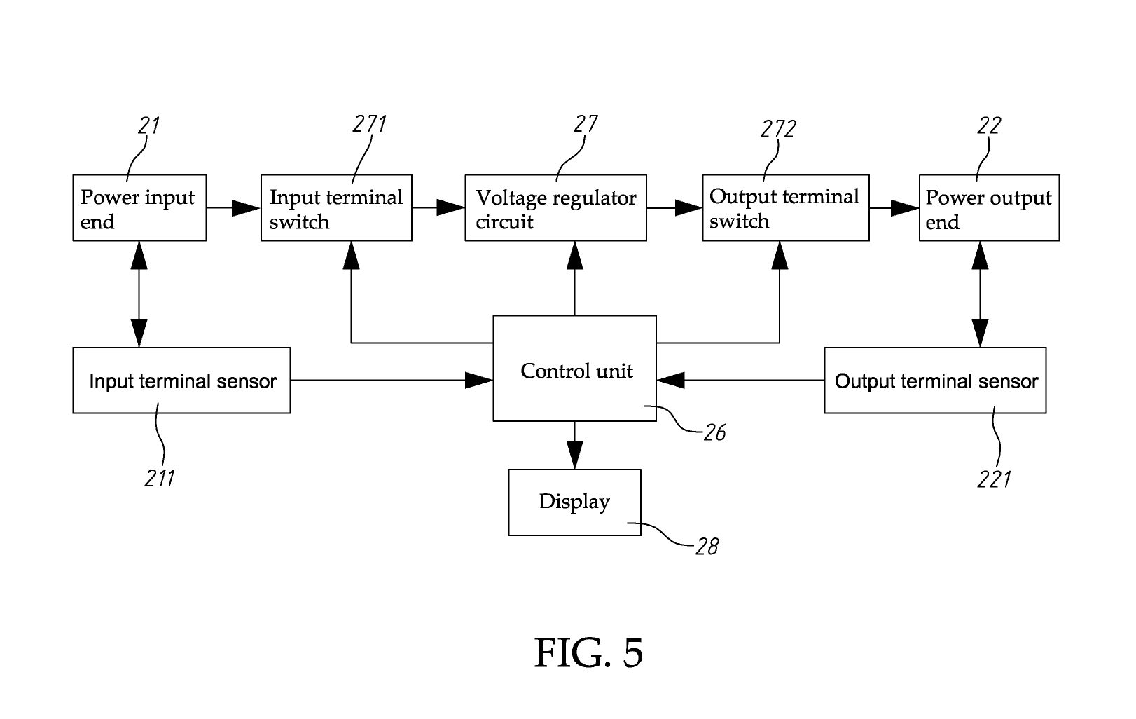

Referring to FIG. 5, the vehicle emergency starter supplementary device further comprises a control unit 26 mounted inside the housing 20, a voltage regulator circuit 27 mounted inside the housing 20 and electrically connected to the control unit 26 with its input end electrically coupled with the power input end 21 and its output end electrically coupled with the power output end 22, an input terminal switch 271 electrically connected between the power input end 21 and the input end of the voltage regulator circuit 27 and controllable by the control unit 26 for power input, an output terminal switch 272 electrically connected between the output end of the voltage regulator circuit 27 and the power output end 22 and controllable by the control unit 26 for power output, an input terminal sensor 211 electrically connected to the power input end 21 and the control unit 26 and controllable by the control unit 26 to detect the voltage of the input power supply, an output terminal sensor 221 electrically connected to the power output end 22 and the control unit 26 and controllable by the control unit 26 to detect the voltage of the output power supply, and a display 28 mounted on the outside of the display 28 and electrically connected to the control unit 26 for displaying detected data and other related charging data. Further, the display 28 can be a LED display, a LCD display, or any other communication interface module display.

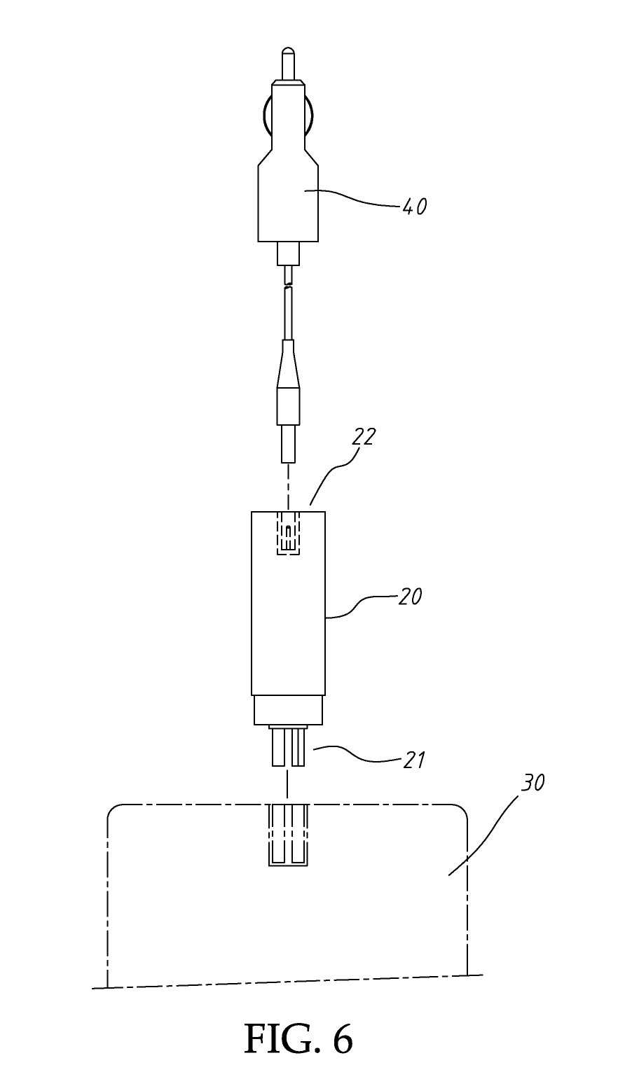

Referring to FIG. 6, in application, connect the plug terminals 23 of the power input end 21 of the vehicle emergency starter supplementary device to a mobile power supply device 30, and then use a cigarette lighter receptacle applicable power cable 40 to connect the electric jack 24 of the power output end 22 of the vehicle emergency starter supplementary device to a cigarette lighter receptacle in a vehicle (such as car), and then operate the vehicle emergency starter supplementary device to charge the internal battery of the vehicle.

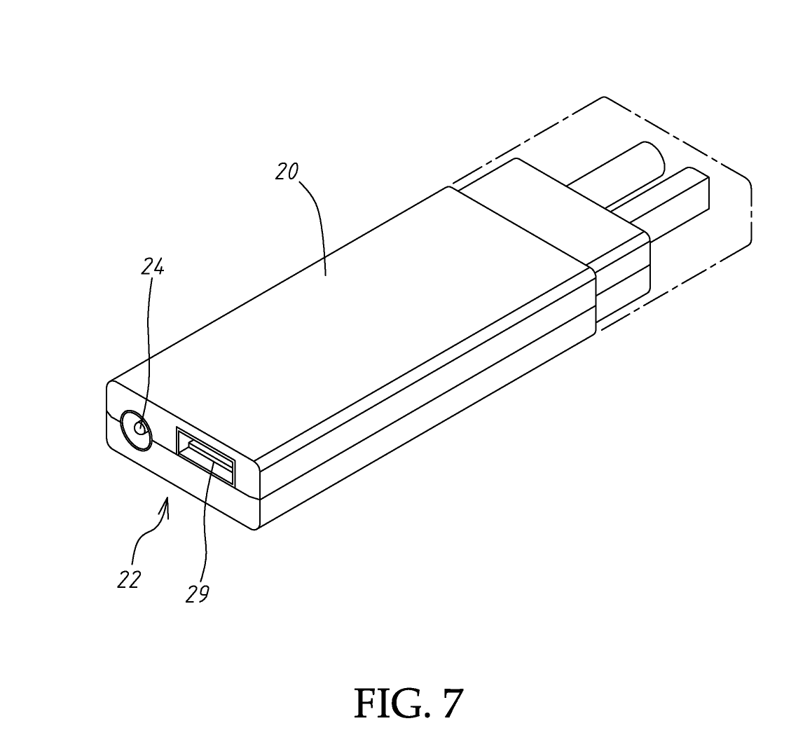

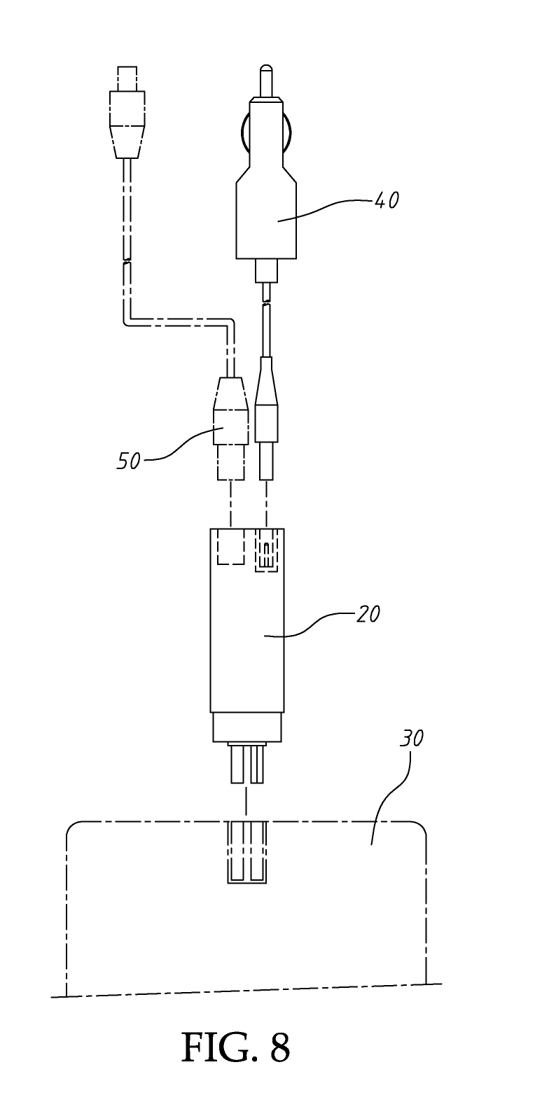

Referring to FIG. 7, the power output end 22 of the vehicle emergency starter supplementary device can be configured to provide a USB (Universal Serial Bus) jack 29. Thus, the user can selectively use a cigarette lighter receptacle applicable power cable 40 or a USB cable 50 (see FIG. 8) to connect the electric jack 24 of the power output end 22 of the vehicle emergency starter supplementary device to a cigarette lighter receptacle in a vehicle (such as car) or the USB jack 29 of the power output end 22 of the vehicle emergency starter supplementary device to a USB port of an external electronic device.

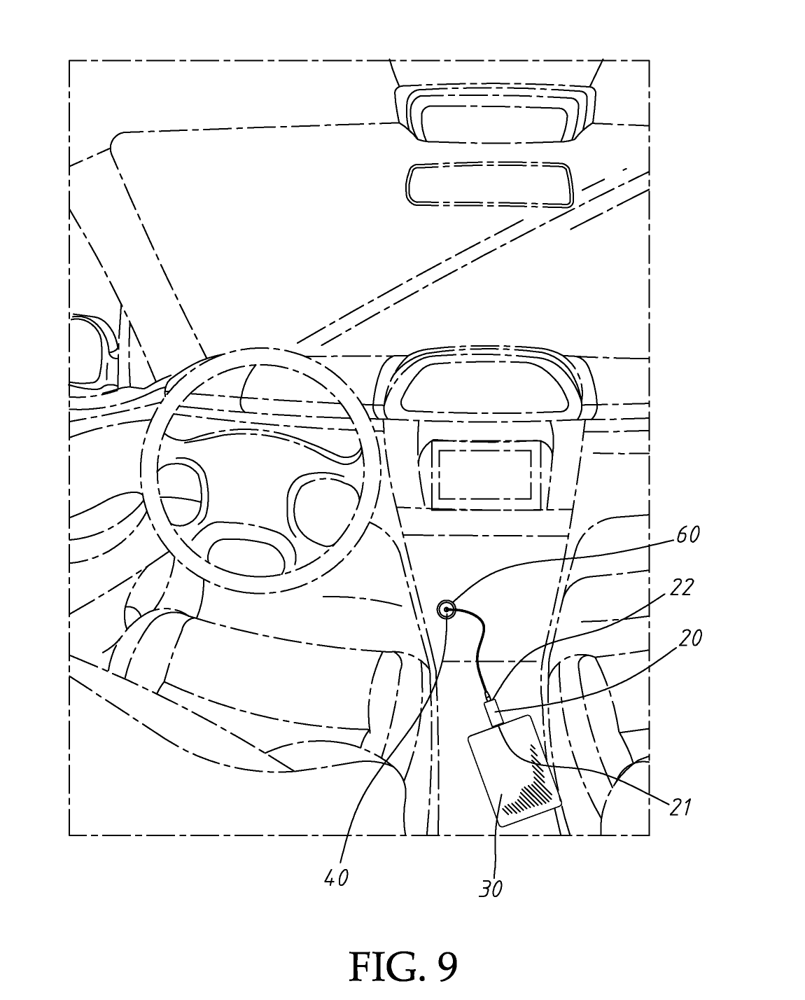

Referring to FIG. 9, when using the vehicle emergency starter supplementary device in a motor vehicle (such as car), connect the plug terminals 23 of the power input end 21 of the vehicle emergency starter supplementary device to a mobile power supply device 30, and then use a cigarette lighter receptacle applicable power cable 40 to connect the electric jack 24 of the power output end 22 to an internal charging device (for example, the cigarette lighter receptacle 60 of the motor vehicle). At this time, the driver staying inside the vehicle can switch on the vehicle emergency starter supplementary device to charge the vehicle battery of the motor vehicle with the mobile power supply device 30 without leaving the motor vehicle.

In conclusion, the invention provides a vehicle emergency starter supplementary device, which allows the driver of a motor vehicle (car, motorcycle, water scooter, etc.) to charge the motor vehicle with a mobile power supply device conveniently without leaving the motor vehicle, enhancing the probability of successful rescue at a low temperature.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A vehicle emergency starter supplementary device, comprising a housing, a power input end located at one end of said housing for the connection of an external mobile power supply device, a power output end located at an opposite end of said housing, a control unit mounted inside said housing, a voltage regulator circuit mounted inside said housing and electrically connected to said control unit, said voltage regulator circuit having an input end thereof electrically coupled with said power input end and an output end thereof electrically coupled with said power output end, an input terminal sensor electrically connected to said power input end and said control unit and controllable by said control unit to detect the voltage of a power supply being inputted into said power input end, an output terminal sensor electrically connected to said power output end and said control unit and controllable by said control unit to detect the voltage of the power supply being outputted through said power output end, and a cigarette lighter receptacle applicable power cable adapted for electrically and detachably connecting said power output end to a cigarette lighter receptacle in a motor vehicle.

2. The vehicle emergency starter supplementary device as claimed in claim 1, further comprising an input terminal switch electrically connected between said power input end and the input end of said voltage regulator circuit and controllable by said control unit for power input, and an output terminal switch electrically connected between the output end of said voltage regulator circuit and said power output end and controllable by said control unit for power output.

3. The vehicle emergency starter supplementary device as claimed in claim 1, further comprising a display electrically connected to said control unit and controllable by said control unit to display data.

4. The vehicle emergency starter supplementary device as claimed in claim 3, wherein said display is selected from the group of LED display, LCD display and communication interface module display.

5. The vehicle emergency starter supplementary device as claimed in claim 1, wherein said power output end further comprises a USB connector for connection to an external electronic device through a USB cable.
